(19) United States
(12) Patent Application Publication
(10) Pub. No.: US 2026/0004144 A1
(43) Pub. Date: Jan. 1, 2026

(54) MACHINE LEARNING MODELS FOR PREDICTING MISSING VALUES FROM DATA SETS

(71) Applicant: Toyota Motor Engineering & Manufacturing North America, Inc., Plano, TX (US)

(72) Inventors: Jaydeep THIK, Ann Arbor, MI (US); Chen LING, Troy, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/940,425

(22) Filed: Nov. 7, 2024

Related U.S. Application Data
(60) Provisional application No. 63/665,806, filed on Jun. 28, 2024.

(51) Int. Cl. G06N 3/094; G06N 3/0455

(52) U.S. Cl. CPC G06N 3/094; G06N 3/0455

(57) ABSTRACT

A computing system may include a processor and a memory having a set of instructions, which when executed by the processor, cause the computing system to execute actions. The actions include identifying an estimate of a distribution of missing block patterns, generating a noisy dataset by removing first data from an original dataset based on the estimate and training a denoising autoencoders (DAE) based on the noisy dataset.

### CROSS-REFERENCE TO RELATED APPLICATION

The present application claims the benefit of priority to U.S. Provisional Patent Application 63/665,806, filed on Jun. 28, 2024.

### TECHNICAL FIELD

Embodiments generally relate to machine learning models. In detail, examples relate to an enhanced denoising autoencoder that predicts values for missing data.

### BACKGROUND

Machine learning (e.g., neural networks, deep neural networks, etc.) workloads may include a significant amount of operations and operate over various contexts. For example, machine learning models may include numerous nodes that each execute different operations based on particular data. Such operations may include General Matrix Multiply operations, multiply-accumulate operations, etc. The operations may consume significant data, memory and processing resources to execute. The machine learning models may be trained in an iterative process for various purposes.

### BRIEF DESCRIPTION OF THE SEVERAL VIEWS OF THE DRAWINGS

The various advantages of the embodiments of the present disclosure will become apparent to one skilled in the art by reading the following specification and appended claims, and by referencing the following drawings, in which:

FIG. 1 is a diagram of an example of a training process for a machine learning model;

FIG. 2 is a diagram of an example of a flowchart illustrating data curation, preprocessing, missing patterns sampling and training of a machine learning model;

FIG. 3 is a diagram of an example of a missing pattern sampling flowchart;

FIGS. 4A, 4B and 4C are diagrams illustrating the effectiveness of enhanced examples;

FIG. 5 is a diagram of an example of a computing system; and

FIG. 6 is a diagram of an inference process according to some examples.

### DETAILED DESCRIPTION

In the era of data-intensive deep learning models, the role of abundant and high-quality data has been magnified and increased. Prioritizing data quality has become increasingly of interest to unleash the full potential of state-of-the-art models (e.g., machine learning models). A machine learning model trained on poor quality data has several negative ramifications including inaccurate predictions, misleading performance quantifications (e.g., data leakage causes positive performance when the model is poorly trained), and bias among others. Thus, significant effort is placed on training ML models on high quality data to ensure that the resulting trained ML models produce accurate results in the real world.

In many cases however, training data is “noisy.” That is, due to the nature of data storage and real-word computer constraints (e.g., hardware failures, faulty software overriding data, malware, power outages, file system damage, etc.) data values may be missing, corrupted, etc. The above may be particularly relevant for machine learning systems that rely on structured databases. For example, structured databases are more susceptible to data contamination and noise (e.g., duplications and missing values).

Data contamination and noise, among other data related issues, may have severe repercussions on machine learning model performance as noted above. Indeed, such missing and noisy data may deleteriously impact machine learning model training and inference. For example, machine learning models that operate on noisy and missing data during inference may have difficulty generating correct predictions due to the incorrect data that is used to train the machine learning models.

In some prior existing examples, machine learning models are trained on complete (not noisy and/or incomplete datasets), and lack the ability to operate on noisy and/or incomplete datasets during inference. Doing so, however, has several technological complications. For example, the amount of complete datasets may be insufficient to accurately train a machine learning model. That is, the machine learning model may not accurately operate during inference as the machine learning model is trained over a small dataset. Furthermore, even if sufficient complete data exists, the machine learning models are still unable to operate over noisy datasets and/or incomplete datasets limiting the effectiveness of the machine learning models.

Furthermore, noisy datasets, despite the errors, may still provide a valuable source of training data. As such, discarding the noisy datasets is often times a deficient approach to dealing with the noisy datasets.

Moreover, in some applications discarding the noisy datasets is not possible. For example, in some cases (e.g., sensor readings, bank accounts, health information, etc.) datasets contain valuable information that would be complicated to recreate, and therefore cannot be discarded. Such cases seek to determine the most likely values for missing data rather than discarding the datasets altogether.

Prior existing implementations may include multiple sub-optimal procedures to deal with noisy data (e.g., missing values in structured data such as tabular data) in order to transform the noisy data into serviceable data for training, inference and/or execute other operations. A first procedure involves the deletion of missing entities and imputing (e.g., replace the missing values with plausible values) with statistical measures like mean, median and mode for each feature and/or column. Doing so is part of the process to address the missing values before performing data analysis and/or training.

That is, ignoring, or deletion of missing values may lead to reduced datasets with potential loss of crucial information for any significant downstream (e.g., inference) task. Thus, prior existing implementations employed statistical imputation methods to recreate the missing data. Statistical imputation methods may suffer from poor performance. For example, prior existing implementations may be unable to accurately operate on outliers in the datasets resulting in inaccurate imputed values.

For example, due to the presence of outliers in the non-missing data, the imputed value may be significantly different when using statistical methods like mean imputations. For example, suppose that a column mostly contains the value “1,” but there are a few outliers values like “100” and “200.” The mean of these values will be far greater than “1” which will be used as the imputed value, thus deviating from the logical value of 1 for missing values. That is, the most common value in the column is “1,” and therefore the most likely value for missing data would be “1.” The imputed value however will be a number far greater than “1” due to the skewing effect of outliers on the mean imputation.

Thus, addressing outliers may rely on domain expertise by a human and other statistical measures, which may be time consuming and prone to error. Accordingly, prior existing implementations lacked the technological capability to autonomously address, and accurately remedy noisy data resulting in poor performance, reduced operational capabilities and reduced opportunities to train machine learning models.

Recently, there have been efforts to harness the capabilities of deep learning methods, like Denoising Autoencoders (DAEs), for prediction of missing values in a tabular dataset (e.g., “Smart Meter” related data, employee data, customer data, vehicle data, etc.). A training method of DAEs involves analyzing statistics of the missing blocks of length l≥1 in the datasets and noting all distinct block lengths. Ground truth data is prepared by mean imputation of the features followed by normalizing the data by dividing by the maximum value.

During the data corruption stage, artificial missing patterns according to the given missing duration are generated and data is duplicated. For example, if l=4, then {xₜ|t=0, 1, 2, 3}, are missing in a first pattern (e.g., a first record associated with a first reading from a Smart Meter at a first time), and {xₜ|t=4, 5, 6, 7} are missing for a next pattern (e.g., the same first record) for each row. This results in duplication of each row (e.g., record) where the block length is missing at different locations in a sliding window fashion with a stride of l. Using the generated pattern and strides, corruptions are introduced by setting the values at the pattern location as “0” to represent missing status. In addition, a binary missing mask is generated to reflect the positions of missing data. For example, the binary missing mask may have a “1” value for each position in the dataset where a missing value is present, and a “0” for the other positions in the dataset where non-noisy data (e.g., accurate data) is present.

The corrupted data along with the binary missing mask is passed as inputs to the DAE. The DAE is trained based on the binary missing mask and the corrupted data to predict the missing values using the ground truth data. The corrupted data along with the binary missing mask is passed as inputs to the DAE. The DAE is trained to predict missing values in a training process that includes determining values for the corrupted data based on the missing mask, and updating the DAE based on the ground truth data and determined values. In existing examples, the data preparation involves duplication of data points resulting in potential information leakage and other issues discussed below.

As noted above, the prior existing implementations suffer from issues that may have severe repercussions on machine learning model performance, especially when compared to unstructured data modalities (e.g., text, images, and audio that is unable to be stored in a tabular format). Structured databases (e.g., organized, searchable and is able to be stored in a data table and/or matrix), notably tabular data, are often not constructed with data analysis as a priority. Consequently, the presence of missing values is a pervasive challenge in structured data. Improper handling of missing values may lead to significant technical problems such as bias, poor model convergence and poor generalizability in future data analysis. Such technical problems may escalate more when the fraction of the missing values is large, thus resulting in degrading quality of predictions.

Thus, several technological problems are outlined above. For example, missing structured data stored in databases (e.g., on computer devices) may have significant negative impacts on several technological processes, including machine learning, data processing, data mining, etc. Missing structured data can affect other processes as well including data visualization, data extraction, data analysis, correlations, statistics, time series analysis, decision making, etc.

Enhanced technological examples herein include an enhanced data structuring and healing approach aimed at comprehensively addressing the issue of missing values in structured data (e.g., tabular datasets that include data being stored in tables and/or columns and rows) to generate an enhanced DAE. Examples first involve gaining insights into the distribution of missing patterns within the data. Subsequently, examples include a strategy for sampling from this distribution to train a DAE (e.g., a machine learning model such as a neural network) capable of predicting missing values. A DAE may be a neural network that removes noise from data by learning to reconstruct the original data from a noisy version of the original data (e.g., predicts the missing values).

Enhanced examples herein leverage two points identified from the missing data patterns that are exploited. One, the missing values in the data occur in contiguous blocks of different lengths across one or more rows. Secondly, such blocks of different lengths have a distribution. Enhanced examples leverage these observations and develop a sampling-based method to sample missing masks from the observed missing blocks distribution and predict the missing values using the DAE. Doing so reduces and/or prevents unnecessary data duplication and faster convergence of DAEs unlike current methods and provides a much smaller error in predicting missing values across different missing percentages of data. Examples herein also consider the empirical percentage of missing data as a parameter for sampling from the observed missing blocks distribution which is absent from existing examples.

Thus, DAEs as described herein operate in a technological environment of a data recreation in a computing environment where the data has been corrupted. Furthermore, DAEs as described herein have increased accuracy relative to prior existing examples, and are trained in less iterations with less data. Doing so results in less processing power, reduced training times, increased accuracy, less memory usage and enhanced functionality. Thus, examples herein improve a technological field (e.g., DAE training, DAE inference, data storage and healing noisy data). In order to achieve the aforementioned technological enhancements, examples identify an estimate of a distribution of missing block patterns, generate a noisy dataset by removing first data from an original dataset based on the estimate, and train a denoising autoencoders (DAE) based on the noisy dataset.

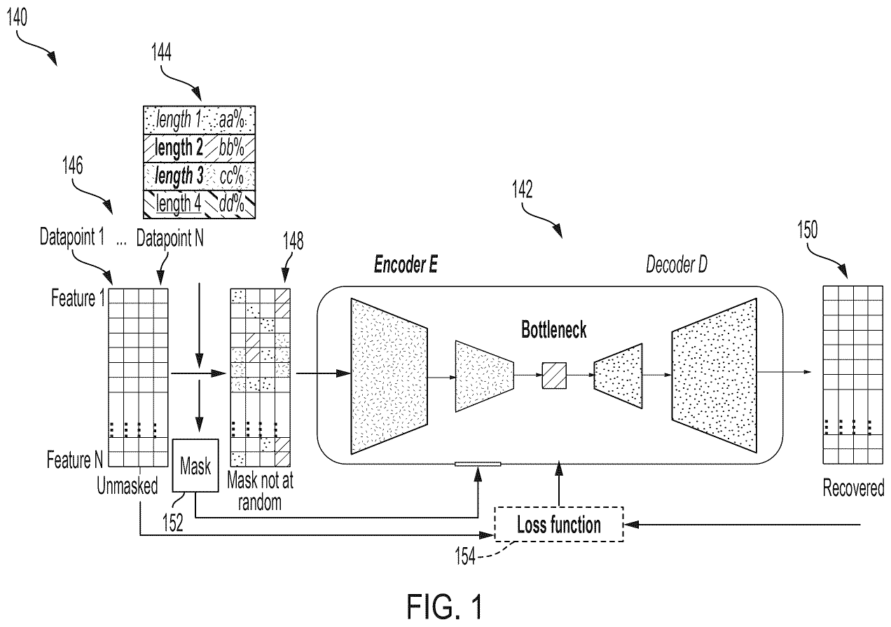

FIG. 1 illustrates an enhanced DAE training process 140 for missing value prediction based on missing block pattern sampling. enhanced DAE training process 140 may be implemented in logic instructions (e.g., software), a non-transitory computer readable storage medium, circuitry, configurable logic, fixed-functionality hardware logic, computing device, etc., or any combination thereof.

In this example, an original dataset 146 is in a structured data format (e.g., table) and includes a number of data points ranging from datapoint 1 to datapoint N. The datapoints of the original dataset 146 each span a column and includes features 1-feature N aligned along the rows. Thus, each datapoint of the datapoints 1-N includes multiple features. The datapoints may represent any suitable data, including customer information, sensor readings, vehicle data, etc.

In this example, original dataset 146 is complete and non-noisy, or has a minimal amount of noise (e.g., less than 1% of original dataset 146 is noisy data). That is, the original dataset 146 does not contain missing values and/or corrupted values.

In this example, missing block statistics 144 are generated. The missing block statistics 144 may be reflective of missing block data that is missing from datasets. For example, a number of datasets (e.g., a sample set size that accurately represents the population of data and allows for reliable statistical analysis) may be analyzed to determine how many missing blocks are missing, sizes of the missing blocks (e.g., each size may be how many bits in a contiguous row(s) are missing), and proportions of the missing block sizes (e.g., proportions and/or percentages that reflect an amount of missing blocks relative to the overall amount of missing blocks of the datasets). For example, a first size of the missing blocks may be set to one (e.g., one data block missing), a second size of the missing blocks may be set to two (e.g., two contiguous data blocks in a row missing), a third size of the missing blocks may be set to three (e.g., three contiguous data blocks in a row missing), etc. depending on unique block lengths identified. The number of contiguous blocks of different lengths are first identified using computer code executed by a computing device, server, etc. The number of unique lengths then represents the bits (e.g., length of one is a one missing bit, length of two is two missing bits, etc.) of the missing blocks.

In some examples, the missing blocks analysis and identification continues until a threshold proportion amount of total missing blocks is reached. For example, the proportion threshold may be set to a percentage value (e.g., 90% or 95% of total missing blocks across all the datasets). The largest proportions of missing block sizes are analyzed and added together until the threshold is reached. Once the summation of the largest proportions reaches the proportion threshold, the analysis of the missing blocks may cease to avoid processing overhead and diminished returns on the computing resources dedicated to the analysis.

Thus, the missing block statistics 144 may be an estimate of a distribution of missing block patterns. The distribution of missing block patterns may include different block lengths (sizes) and a percentage of the block sizes that are missing on average from the datasets. That is, the missing block statistics 144 includes a proportion of blocks (e.g., aa %, bb%, cc %, and dd %) that are missing, and sizes of the blocks (e.g., length 1, length 2, length 3 and length 4) that are missing.

Thus, the datasets may each have different amounts of blocks that are missing and different proportions of the sizes of the missing block patterns. Thus, examples may categorize the distinct missing blocks into categories (e.g., lengths) and generate percentages of categories (e.g., a percent that is the number of missing blocks of the category relative to the total amount of the missing blocks of all categories).

Prior existing examples may train autoencoders by duplicating data and using stride lengths to remove data (described above) in a random fashion, enhanced examples herein avoid data duplication and train an autoencoder based on a missing block statistics 144 which represents real-world scenarios. As a consequence, the aforementioned drawbacks of the prior existing examples are avoided, such as data duplication, data leakage, poorly performing autoencoders that provide suboptimal results. That is, in existing examples data is not removed at random (as in prior existing examples), and is instead removed in an organized fashion based on the missing block statistics 144.

Therefore, the missing block statistics 144 may be an estimate of the missing blocks. The estimate includes the lengths of blocks that are missing from a dataset (e.g., during inference and in real-world situations), and second proportions of percentages of the block lengths that are missing. For example, 20% of blocks may be missing from the original dataset 146 overall. From that 20% of missing blocks of the original dataset 146, 10% may have a length1 (e.g., one block or one value missing), 30% may have a length2 (e.g., two blocks or two values in a row missing), 40% may have a length3 (e.g., three blocks or three values missing) and 10% may have a length4 (e.g., four blocks or four values missing). Thus, a threshold proportion is set to 90%, and when the total amount of proportions of the lengths of blocks that are analyzed thus far reaches 90% the analysis may cease. Therefore, other missing block lengths (e.g., length 5, length 6, etc.) may be ignored as such other missing block lengths contribute a statistically insignificant amount.

Examples generate the noisy data 148 by removing data from the original dataset 146 based on the missing block statistics 144. That is, the noisy data 148 has missing data that corresponds to (e.g., is equal to) the missing block statistics 144. A mask 152 that corresponds to locations of missing data in the noisy data 148 is also generated. The mask 152 may use any value for missing data. For example, the mask 152 reflects each of the positions of the noisy data 148, and whether the positions are noisy are non-noisy. For example, in the mask 152 a bit value of “1” at a first position may correspond to data in a corresponding first position of the noisy data 148, and indicate that the data at the first position in the noisy data 148 is missing (noisy). Similarly, during inference the mask is generated for the inference data and then provided to the DAE through an automated process (e.g., data is analyzed to detect where missing data is located and generates a mask accordingly).

Examples train the DAE 142 based on the noisy dataset 148, and the mask 152. The DAE 142 includes an encoder E and a decoder D that operate together as a neural network. The noisy data 148 (e.g., sampled corrupted data) along with mask 152 (e.g., the generated missing mask) is passed as inputs to the DAE 142. The DAE 142 then attempts to predict values for the missing data in the noisy data 148 to generate output 150 based on the mask 152. The output 150 may include the predicted values at the corresponding positions for the missing data. That is, the DAE 142 attempts to predict the missing data in the noisy data 148.

The output 150 is compared to the ground truth, or the original dataset 146 in this example to generate a loss. In particular, the predicted values for missing data are compared to the actual values for the missing data to determine the loss. That is, the loss function 154 may generate the loss based on the correctness of the output 150, and in particular how closely the predicted values in the output 150 matches the actual values in the original dataset 146.

Thus, the DAE 142 is trained using the original dataset 146 (e.g., ground truth data) to predict the missing values. The DAE 142 is updated based on the loss from the loss function 154.

In some examples, the enhanced DAE training process 140 also employs swap noise on the original dataset 146 to generate noisy data 148. For example, a percentage (e.g., 15%) of the features of the original dataset 146 of one row in the original dataset 146 are swapped randomly with another row of the original dataset 146 to generate the noisy data 148 and inject small noise. Swap noise has proved to be useful in combatting overfitting, particularly in tabular data-based methods.

The output 150 is compared to the original dataset 146 through a loss function. The loss function generates a loss based on the comparison of the output 150 to the original dataset 146 and how closely the output 150 matches the 146.

The enhanced DAE training process 140 may repeat over different datasets and training a different DAEs 142 for different purposes. That is, a first DAE may be trained according to DAE training process 140 based on noisy water sensor data and to detect missing values in the noisy water sensor data, while a second DAE may be trained according to DAE training process 140 based on noisy heat sensor data and to detect missing values in the noisy heat sensor data. Thus, the enhanced DAE training process 140 is generalizable to different scenarios and datasets.

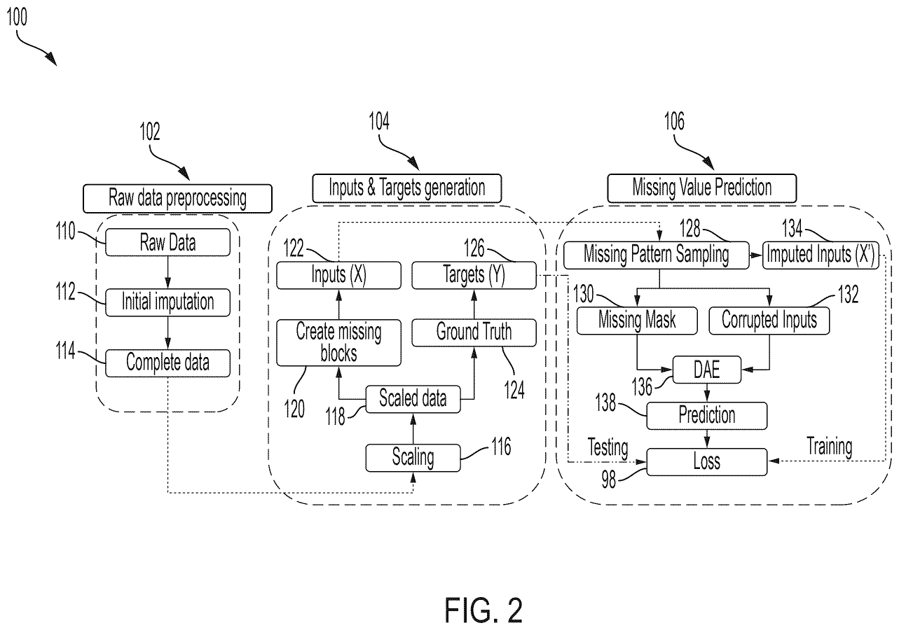

Turning now to FIG. 2, a flowchart 100 is illustrated that describes data curation, preprocessing, missing patterns sampling and training of DAEs for missing values prediction. The flowchart 100 may be incorporated into and be used as part of enhanced DAE training process 140 (FIG. 1). The flowchart 100 may be implemented in logic instructions (e.g., software), a non-transitory computer readable storage medium, circuitry, configurable logic, fixed-functionality hardware logic, computing device, etc., or any combination thereof.

Initially, the raw data is preprocessed 102 in a series of operation. The raw data 110 (e.g., ground truth data) is downloaded. The raw data 110 may contain some amount of missing data initially as long as the missing data is a minimal amount (e.g., less than 1% of the total data). The raw data 110 may include a dataset in which each of the datapoints include a same set of features, with different values for the features. The raw data 110 is subjected to initial imputation 112. Through the initial imputation 112, all the pre-existing missing values are imputed with the mean (e.g., mean imputation) of the features to generate complete data 114 that includes the mean of missing features. Thus, the complete data does not include any missing values, and some of the values are imputed based on the mean features. For example, if a first feature of a first feature dataset is missing, the value of the first feature may be set to the mean of the first features of the other features of the dataset that have non-noisy values (not missing and/or imputed values).

The flowchart 100 includes inputs and targets generation 104. Inputs and targets generation 104 includes scaling 116. The scaling 116 includes scaling the dataset by subtracting the mean of the dataset for each feature and dividing by the standard deviation of the dataset for each feature. The scaling 116 scales the complete data to generate scaled data 118. The scaling 116 may remove biases and/or outliers in the complete data 114.

The inputs and targets generation 104 creates missing blocks 120 based on a distribution of missing block sizes. For example, the targets generation 104 may selectively generate noise in an intentional manner based on the distribution, which may be similar to missing block statistics 144 (FIG. 1), to generate inputs (X) 122.

The creation of missing blocks 120 may create several datasets and/or versions of the complete data 114 that correspond to different Pₘ % of values missing data. For example, a first dataset may be generated based on a total missing block percentage of 10% being removed from complete data 114 based on the distribution. The first dataset may correspond to the complete data 114 with 10% noisy data. A second dataset may be generated based on a total missing block percentage of 20% being removed from complete data 114 based on the distribution. The second dataset may correspond to the complete data 114 with 20% noisy data. The third dataset may be generated based on a total missing block percentage of 30% being removed from complete data 114 based on the distribution. The third dataset may correspond to the complete data 114 with 30% noisy data. A fourth dataset may be generated based on a total missing block percentage of 40% being removed from complete data 114 based on the distribution. The fourth dataset may correspond to the complete data 114 with 40% noisy data. Notably, in each of the first-fourth datasets, the missing data corresponds to the same distribution. Thus, for each of the first-fourth dataset, missing blocks are created from the distribution (may be predefined), resulting in inputs (X) 122. The inputs (X) 122 may include the first-fourth datasets that are used to train and validate a DAE during various iterations of missing value prediction 106.

A scaled ground truth data 124, which may be the scaled data 118 with no interjected noise, is used as Targets (Y) 126. Examples split the inputs (X) 122 into training, validation, and test datasets (e.g., the training datasets includes training data, the validation datasets includes validation data and the test datasets include test data). Each of the first-fourth datasets may have a training, validation, and test dataset.

The training set is used to train DAEs with the proposed sampling-based method described in output enhanced DAE training process 140. The validation set is used to decide the best set of hyperparameters like learning rate, batch-size and number of layers in the DAEs. The final evaluation of missing value prediction is carried out on the final test set.

In this example, the missing value prediction 106 executes missing pattern sampling 128 based on training data which may be from each of the first-fourth datasets (e.g., the training data from the first-fourth dataset). Thus, the training data may be a noisy dataset that is selected from first-fourth dataset (e.g., a subset of the first-fourth dataset that is reserved for training while other subsets of the first-fourth dataset are reserved for validation and testing). The missing pattern sampling 128 generates imputed inputs (X′) 134 which replaces noisy data from the training data with imputed values (e.g., mean imputation values as described above, referred to as mean imputed values). Doing so may enhance training since the real-world values are not always known and an imputation may more closely simulate real-world conditions.

The testing data may not be used at this time. The missing value prediction 106 generates missing mask 130 (e.g., a missing data mask) representing positions of missing values in the training data, distribution of missing data, proportions of the missing data, etc. Corrupted inputs 132 may also be provided which is the training data. During training, corrupted inputs 132 (e.g., corrupted training data) and missing mask 130 (e.g., sampled training missing mask) is used as an input to train the DAE 136.

During testing (e.g., simulation of inference), examples may not recalculate the distribution (assumption during training is that test data has the same missing block distribution as training data). Instead the mask is generated from the test data itself which is provided with test data (containing missing values that are represented by ‘0’) as inputs to DAE for prediction.

The missing mask 130 and corrupted inputs 132 are provided to a DAE 136 for training. The DAE 136 generates a prediction 138 of the missing values (e.g., predicted values of the missing values) based on the missing mask 130 and the corrupted inputs 132. During training, the missing value prediction 106 then generates a training loss by comparing imputed inputs (X′) 134 to the predictions 138 of the DAE (e.g., ground truth) during training. Notably, the loss may not be generated based on the targets (Y) 126 during the training. The DAE 136 (e.g., a machine learning model such as a neural network) is updated based on the loss 98. The missing value prediction 106 is repeated is for each of the training datasets of the first-fourth datasets.

During the testing phase, the testing data noted above is used in the missing value prediction 106 similarly to as described above except that the error is reported by comparing targets (Y) 126 with DAE predictions of values for the noisy data in the testing data. Notably, the imputed inputs (X′) may not be used during the testing phase. During the validation phase (which may not need to determine the imputed inputs (X′)), the validation data noted above is used in the missing value prediction 106 and the error is reported by comparing targets (Y) 126 with DAE predictions of values for the noisy data in the validation data. Preparation of validation data is similar to training data preparation mentioned above. If a testing error of the testing phase and a validation error of the validation phase are both below a first threshold and a difference between the testing and validation errors is lower than a second threshold, the DAE 136 may be considered as operating acceptably to be used during inference (e.g., training is considered completed).

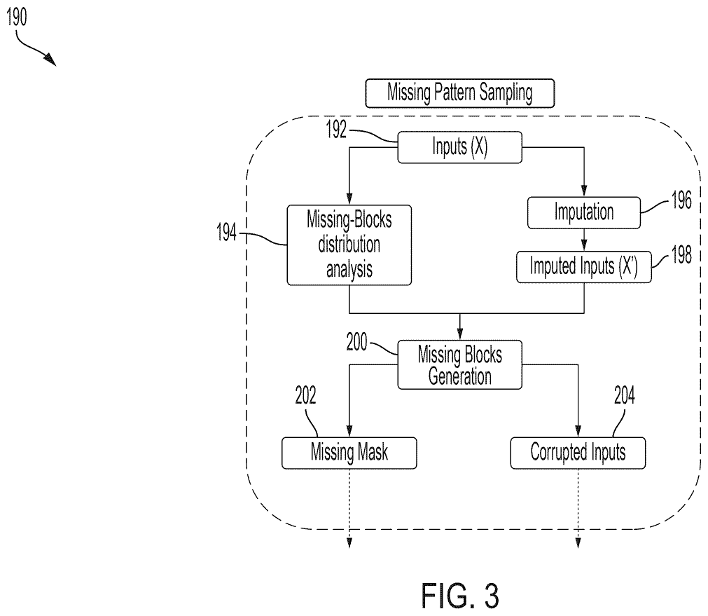

FIG. 3 illustrates a missing pattern sampling flowchart 190. The missing pattern sampling flowchart 190 may be readily implemented as part of missing pattern sampling 128, missing mask 130 and corrupted inputs 132 (FIG. 2). The missing pattern sampling flowchart 190 may be implemented in logic instructions (e.g., software), a non-transitory computer readable storage medium, circuitry, configurable logic, fixed-functionality hardware logic, computing device, etc., or any combination thereof.

Examples analyze statistics of the missing blocks of different lengths in input (X) 192 (e.g., a dataset). That is, a missing-blocks distribution analysis 194 is executed. The missing-blocks distribution analysis 194 includes calculating the distribution of different missing block patterns of length using the inputs (X) 192 (e.g., training dataset), the validation and testing datasets remain untouched during the missing-blocks distribution analysis 194. To approximate the distribution of different block lengths, a frequency of all unique block lengths (e.g., contributing up to 95% of the missing values) is calculated and normalized to form a probability distribution. The percentage of missing values is then calculated in the Inputs (X).

Inputs (X) 192 are then subjected to imputation 196 to generate mean values for missing data. The imputation 196 generates mean values to recreate the missing data in the Inputs (X) and is substituted for the missing data. The imputed values are stored as part of the imputed inputs (X′) 198. During the missing blocks generation 200, the artificial missing patterns are sampled according to the previously generated missing pattern generated in the missing-blocks distribution analysis 194. In total, a percentage of values are set to “0” using the sampled distribution resulting in corrupted inputs 204. Additionally, a binary missing mask 202 is attached based on the sampled missing pattern, which has “1” for missing and “0” for the others. The missing mask 202 and corrupted inputs 204 are output, for example to the DAE 136 (FIG. 2).

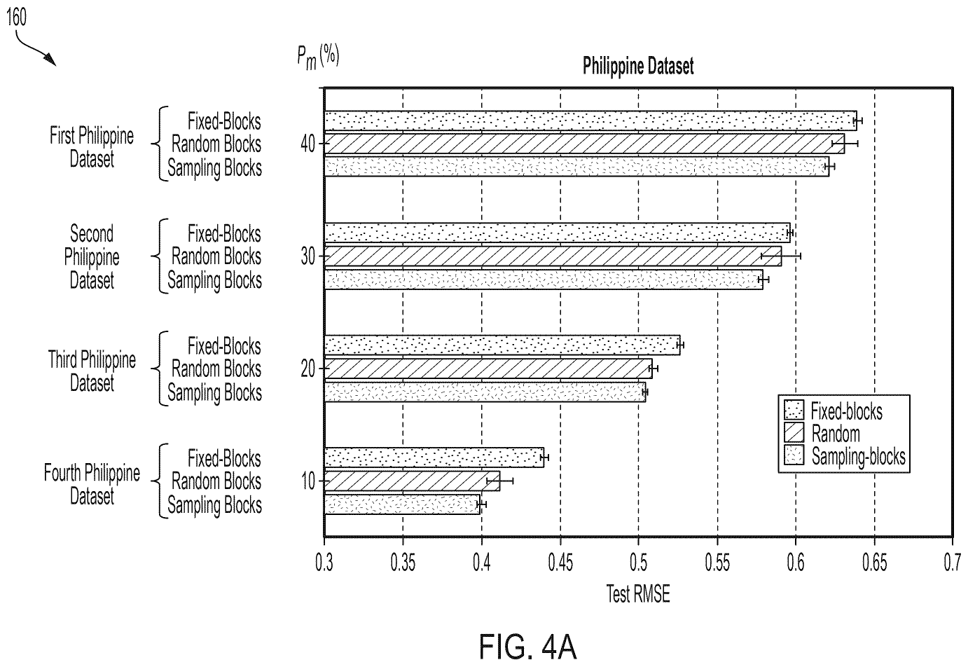

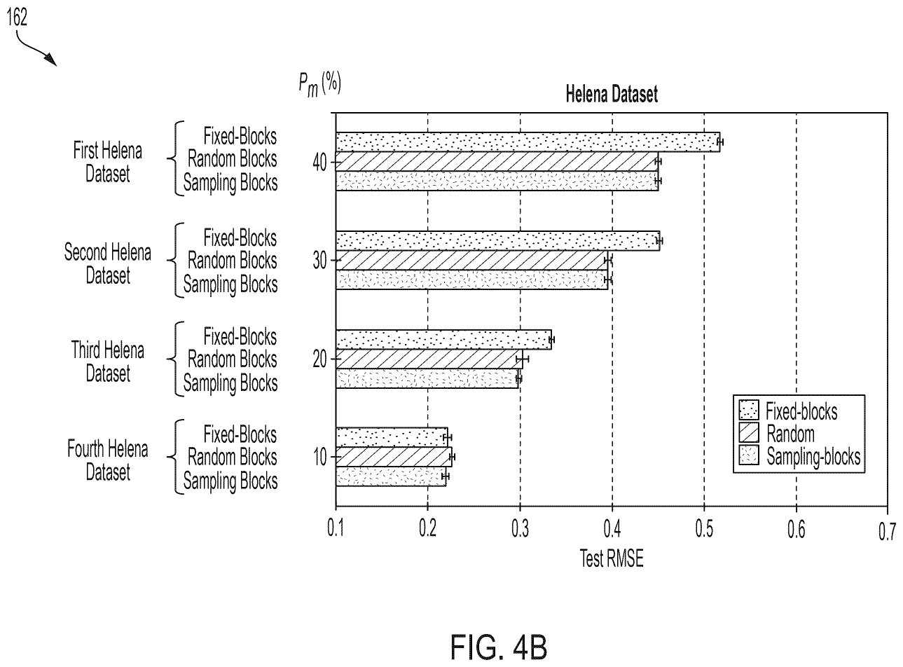

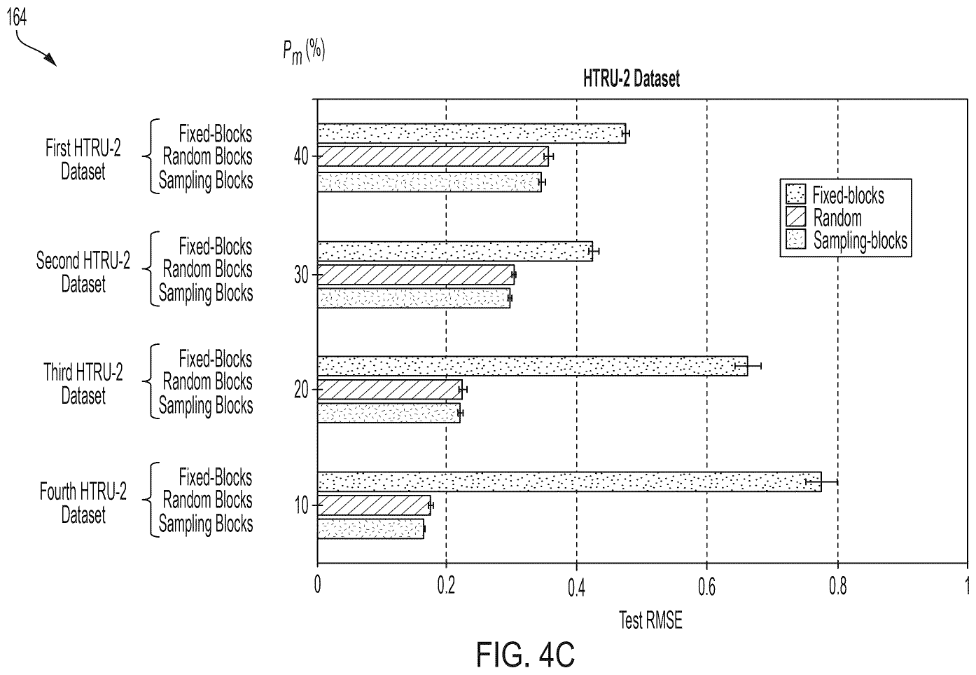

Turning now to FIGS. 4A-4C, examples were examined against three openly available datasets, Philippines (e.g., synthetic datasets), Helena (e.g., synthetic datasets) and HTRU2 (real-world dataset) with different number of features and data points. Examples assessed the capability of sampling-based methods for missing value prediction on numeric features. The impact of different missing values percentages is also assessed.

That is, the datasets are rigorously evaluated against the effectiveness using three publicly available datasets, varying in size and feature complexity. The enhanced approaches are benchmarked against various baselines, showcasing the enhanced examples' ability to increase data quality and thereby significantly improve machine learning model performance. Through empirical validation, examples demonstrate the superiority of enhanced example's sampling-based technique in optimizing the utilization of structured databases and highlight its potential for broader applications in machine learning.

The results of using a sampling-based method for missing value prediction is described. The enhanced examples are benchmarked against the other methods and random sampling. Root mean square error (RMSE) was measured between the actual and predicted missing values across different missing percentages for three different datasets in graphs 160, 162, 164.

In the random block approach, blocks are randomly removed from a dataset to generate randomly noisy data. A random DAE may be trained based on the randomly noisy data.

In the fixed-block approach, fixed-block lengths are removed from the dataset to generate fixed-block noisy data. A fixed-length DAE may be trained based on the fixed-block noisy data.

A sampling block approach may include removing data blocks according to the enhanced examples herein (e.g., based on proportions of missing blocks and corresponding missing block sizes) during training. An enhanced DAE may be trained based on the sampling block approach.

In graph 160, the random DAE, the fixed-length DAE and the enhanced DAE analyze four different Philippine Datasets (noisy datasets with different missing percentages of data (including 40%, 30%, 20% and 10%) to predict missing values from the four different Philippine Datasets. The ground truth for each of the Philippine Datasets (e.g., the missing values) is known and used to determine accuracy. For example, a root mean square error (RMSE) for each of the random DAE, the fixed-length DAE and the enhanced DAE measures the average difference between the random DAE, the fixed-length DAE and the enhanced DAE predicted missing values and the actual values. A lower RMSE corresponds to greater accuracy, while a higher RMSE corresponds to a lower accuracy.

The “sampling blocks” is the RMSE of the enhanced DAE, the “random blocks” is the RMSE of the random DAE, and the “fixed-blocks” is the “RMSE of the fixed-blocks DAE. As illustrated in each of the four different Philippine Datasets, the enhanced DAE has higher accuracy (lower RMSE). As illustrated in graph 160, the enhanced examples herein (shown as the sampling-blocks) had superior performance relative to random and fixed-blocks.

Likewise the graph 162 of FIG. 4B represents accuracy based on Helena datasets. The random DAE, the fixed-length DAE and the enhanced DAE (described above with respect to graph 160 of FIG. 4A) analyze four different Helena Datasets (noisy datasets) with different missing percentages of data (including 40%, 30%, 20% and 10%) to determine missing values. The ground truth for each of the Helena Datasets (e.g., the actual missing values) is known and used to determine accuracy. For example, the RMSE for each of the random DAE, the fixed-length DAE and the enhanced DAE measures the average difference between the random DAE, the fixed-length DAE and the enhanced DAE predicted missing values and the actual values.

The “sampling blocks” is the RMSE of the enhanced DAE, the “random blocks” is the RMSE of the random DAE, and the “fixed-blocks” is the “RMSE of the fixed-blocks DAE. As illustrated in each of the four different Helena Datasets, the enhanced DAE has higher accuracy (lower RMSE). As illustrated in graph 162, the enhanced examples herein (shown as the sampling blocks) had superior performance relative to random and fixed-blocks.

Similarly the graph 164 of FIG. 4C represents accuracy based on HTRU-2 datasets. The random DAE, the fixed-length DAE and the enhanced DAE (described above with respect to graph 160 of FIG. 4A) analyze four different HTRU-2 Datasets (noisy datasets) with different missing percentages of data (including 40%, 30%, 20% and 10%) to determine missing values. The ground truth for each of the HTRU-2 Datasets (e.g., the actual missing values) is known and used to determine accuracy. For example, the RMSE for each of the random DAE, the fixed-length DAE and the enhanced DAE measures the average difference between the random DAE, the fixed-length DAE and the enhanced DAE predicted missing values and the actual values.

The “sampling blocks” is the RMSE of the enhanced DAE, the “random blocks” is the RMSE of the random DAE, and the “fixed-blocks” is the “RMSE of the fixed-blocks DAE. As illustrated in each of the four different HTRU-2 Datasets, the enhanced DAE has higher accuracy (lower RMSE). As illustrated in graph 164, the enhanced examples herein (shown as the sampling blocks) had superior performance relative to random and fixed-blocks.

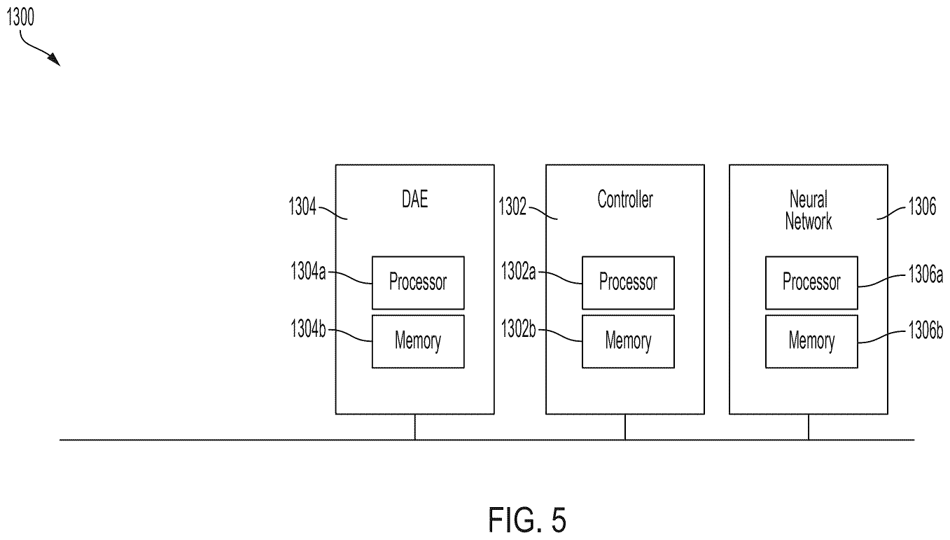

FIG. 5 shows a more detailed example of a computing system 1300 to implement aspects as described herein. In the illustrated example, a controller 1302 includes a processor 1302a (e.g., embedded controller, central processing unit/CPU) and a memory 1302b (e.g., non-volatile memory/NVM and/or volatile memory) containing a set of instructions, which when executed by the processor 1302a, cause the controller 1302 to execute an training process on the DAE 1304 as described above with respect to at least enhanced DAE training process 140 (FIG. 1), flowchart 100 (FIG. 2) and/or missing pattern sampling flowchart 190 (FIG. 3).

The DAE 1304 may also include a processor 1304a (e.g., embedded controller, central processing unit/CPU) and a memory 1304b (e.g., non-volatile memory/NVM and/or volatile memory) containing a set of instructions, which when executed by the processor 1304a execute the training process. The DAE 1304 may also execute inference to predict values for missing values from a tabular dataset.

A neural network 1306 includes a processor 1306a (e.g., embedded controller, central processing unit/CPU) and a memory 1306b (e.g., non-volatile memory/NVM and/or volatile memory) containing a set of instructions, which when executed by the processor 1306a, cause the neural network 1306 to execute processes (e.g., analysis, relationship building, etc.) based on the tabular data with the predicted values.

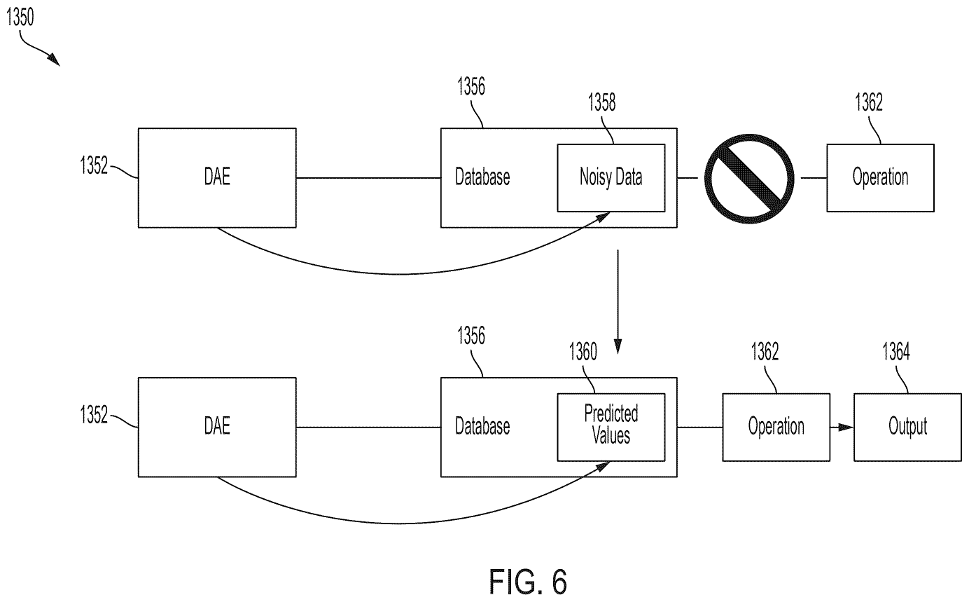

Turning now to FIG. 6, an inference process 1350 is executed. A DAE 1352 may be connected with a database 1356. The 1356 may include noisy data 1358 and thus causing an operation 1362 (e.g., data processing, inference, controlling aspects of a vehicle such as acceleration, velocity, user profile loading, etc. based on data from the database 1356) to fail. That is, the operation 1362 cannot operate on the 1358 and thus fails. The DAE 1352 may then generate predicted values 1360 to replace the noisy data 1358. The DAE 1352 may be trained according to examples herein, including the enhanced DAE training process 140 (FIG. 1), flowchart 100 (FIG. 2) and/or missing pattern sampling flowchart 190 (FIG. 3). Therefore, the operation 1362 may now operate and generate output 1364 based on the operation 1362. Machinery (e.g., vehicles) may be controlled based on the operation 1362, and other decisions may be executed based on output 1364.

The term “coupled” can be used herein to refer to any type of relationship, direct or indirect, between the components in question, and can apply to electrical, mechanical, fluid, optical, electromagnetic, electromechanical or other connections. In addition, the terms “first”, “second”, etc. can be used herein only to facilitate discussion, and carry no particular temporal or chronological significance unless otherwise indicated.

Those skilled in the art will appreciate from the foregoing description that the broad techniques of the embodiments of the present disclosure can be implemented in a variety of forms. Therefore, while the embodiments of this disclosure have been described in connection with particular examples thereof, the true scope of the embodiments of the disclosure should not be so limited since other modifications will become apparent to the skilled practitioner upon a study of the drawings, specification, and following claims.

We claim:

1. A computing system comprising:
a processor; and
a memory having a set of instructions, which when executed by the processor, cause the computing system to:
identify an estimate of a distribution of missing block patterns;
generate a noisy dataset by removing first data from an original dataset based on the estimate; and
train a denoising autoencoders (DAE) based on the noisy dataset.

2. The computing system of claim 1, wherein to train the DAE, the instructions of the memory, when executed, cause the computing system to:
train the DAE to predict values for the first data.

3. The computing system of claim 1, wherein the instructions of the memory, when executed, cause the computing system to:
generate mean imputed values for the first data based on values that remain in the original dataset after the first data is removed from the noisy dataset.

4. The computing system of claim 3, wherein the instructions of the memory, when executed, cause the computing system to:
generate, with the DAE, predicted values for the first data based on the noisy dataset;
generate a loss based on the mean imputed values and the predicted values; and
update the DAE based on the loss.

5. The computing system of claim 1, wherein the instructions of the memory, when executed, cause the computing system to:
generate a missing data mask.

6. The computing system of claim 1, wherein the instructions of the memory, when executed, cause the computing system to:
scale the original dataset based on a mean and standard deviation of features comprising the original dataset.

7. The computing system of claim 1, wherein the estimate includes a proportions of block sizes missing from data.

8. The computing system of claim 1, wherein the noisy dataset and the original dataset are in a tabular format.

9. At least one non-transitory computer readable storage medium comprising a set of instructions, which when executed by a computing device, cause the computing device to:
identify an estimate of a distribution of missing block patterns;
generate a noisy dataset by removing first data from an original dataset based on the estimate; and
train a denoising autoencoders (DAE) based on the noisy dataset.

10. The at least one non-transitory computer readable storage medium of claim 9, wherein to train the DAE, the instructions, when executed, cause the computing device to:
train the DAE to predict values for the first data.

11. The at least one non-transitory computer readable storage medium of claim 9, wherein the instructions, when executed, cause the computing device to:
generate mean imputed values for the first data based on values that remain in the original dataset after the first data is removed from the noisy dataset.

12. The at least one non-transitory computer readable storage medium of claim 11, wherein the instructions, when executed, cause the computing device to:
generate, with the DAE, predicted values for the first data based on the noisy dataset;
generate a loss based on the mean imputed values and the predicted values; and
update the DAE based on the loss.

13. The at least one non-transitory computer readable storage medium of claim 9, wherein the instructions, when executed, cause the computing device to:
generate a missing data mask.

14. The at least one non-transitory computer readable storage medium of claim 9, wherein the instructions, when executed, cause the computing device to:
scale the original dataset based on a mean and standard deviation of features comprising the original dataset.

15. The at least one non-transitory computer readable storage medium of claim 9, wherein the estimate includes proportions of block sizes missing from data.

16. The at least one non-transitory computer readable storage medium of claim 9, wherein the noisy dataset and the original dataset are in a tabular format.

17. A method comprising:
identifying an estimate of a distribution of missing block patterns;
generating a noisy dataset by removing first data from an original dataset based on the estimate; and
training a denoising autoencoders (DAE) based on the noisy dataset.

18. The method of claim 17, wherein the training includes training the DAE to predict values for the first data.

19. The method of claim 17, further comprising:
generating mean imputed values for the first data based on values that remain in the original dataset after the first data is removed from the noisy dataset;
generating, with the DAE, predicted values for the first data based on the noisy dataset;
generating a loss based on the mean imputed values and the predicted values; and
updating the DAE based on the loss.

20. The method of claim 17, further comprising:
generating a missing data mask; and
scaling the original dataset based on a mean and standard deviation of features comprising the original dataset,
wherein the estimate includes proportions of block sizes missing from data,
further wherein the noisy dataset and the original dataset are in a tabular format.
